(19) United States
(12) Patent Application Publication
(10) Pub. No.: US 2019/0066155 A1
(43) Pub. Date: Feb. 28, 2019

(54) CHAT SYSTEM, METHOD OF TRANSMITTING ADVERTISEMENTS, AND RECORDING MEDIUM

(71) Applicant: JVC KENWOOD Corporation, Yokohama-shi (JP)

(72) Inventors: Hideaki Onoda, Yokohama-shi (JP); Jiro Uzaki, Yokohama-shi (JP)

(21) Appl. No.: 16/059,070

(22) Filed: Aug. 9, 2018

(30) Foreign Application Priority Data
Aug. 24, 2017 (JP) 2017-161317

(51) Int. Cl. G06Q 30/02; H04L 12/58

(52) U.S. Cl. CPC G06Q 30/0252; G06Q 30/0277; H04L 51/046

(57) ABSTRACT

A chat system includes a server configured to manage match situation data indicating a situation of a match, chat data indicating content of chats corresponding to the match, and advertisement data relating to advertisements, and transmit the match situation data, the chat data, and the advertisement data; and a chat terminal configured to receive the match situation data, the chat data, and the advertisement data transmitted from the server, generate the chat data, and transmit the generated chat data to the server. The server transmits the advertisement data to the chat terminal based on the match situation data.

### CROSS-REFERENCE TO RELATED APPLICATION(S)

The present application claims priority to and incorporates by reference the entire contents of Japanese Patent Application No. 2017-161317 filed in Japan on Aug. 24, 2017.

### BACKGROUND

The present disclosure relates to a chat system, a method of transmitting advertisements, and a recording medium.

In a sports match or other competitions, some people use an online chat on their mobile terminals to let each other know the current situation of the match so that they can know what is going on in the match. When such a sports match is held, players of the match and the supporters of the players get together and act in group in some cases. For example, the players or the supporters have a meeting and dine together after the match. In this case, it is advantageous to send advertisements for restaurants or conference rooms to the players or supporters. Japanese Laid-open Patent Publication No. 2015-509221 A discloses a method of targeting advertisements to users of a social networking service (SNS) based on interaction information between the users.

Japanese Laid-open Patent Publication No. 2015-509221 A discloses a method of transmitting advertisements based on information extracted from interactions between users. However, it does not mention a method of transmitting advertisements in accordance with a situation of a match.

### SUMMARY

It is an object of the present disclosure to at least partially solve the problems in the conventional technology.

A chat system according to one embodiment includes a server configured to manage match situation data indicating a situation of a match, chat data indicating content of chats corresponding to the match, and advertisement data relating to advertisements, and transmit the match situation data, the chat data, and the advertisement data, and a chat terminal configured to receive the match situation data, the chat data, and the advertisement data transmitted from the server, generate the chat data, and transmit the generated chat data to the server. The server transmits the advertisement data to the chat terminal based on the match situation data.

A method of transmitting advertisements according to one embodiment includes acquiring match situation data indicating a situation of a match, the match situation data being input to a server that manages the match situation data, chat data indicating content of chats corresponding to the match, and advertisement data relating to advertisements, and transmitting the advertisement data, based on the acquired match situation data, from the server to a chat terminal configured to receive the match situation data, the chat data, and the advertisement data, generate the chat data, and transmit the generated chat data to the server.

A non-transitory computer readable recording medium recording therein an advertisements transmission program according to one embodiment for causing a computer to execute an acquisition process of acquiring match situation data indicating a situation of a match, the match situation data being input to a server that manages the match situation data, chat data indicating content of chats corresponding to the match, and advertisement data relating to advertisements, and a transmission process of transmitting the advertisement data, based on the acquired match situation data, from the server to a chat terminal configured to receive the match situation data, the chat data, and the advertisement data, generate the chat data, and transmit the generated chat data to the server.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a block diagram illustrating an example of a chat system according to a first embodiment of the present disclosure;

FIG. 2 is a diagram schematically illustrating an example of advertisement data stored in an advertisement data storage unit;

FIG. 3 is a block diagram illustrating an example of an advertisement management unit;

FIG. 4 is a diagram illustrating an example of an input unit and a display unit of a chat terminal according to the first embodiment;

FIG. 5 is a flowchart illustrating an example operation of the chat system according to the first embodiment;

FIG. 6 is a block diagram illustrating an example of a chat system according to a second embodiment of the present invention;

FIG. 7 is a flowchart illustrating an example operation of the chat system according to a modification; and

FIG. 8 is a flowchart illustrating an example operation of the chat system according to another modification.

### DETAILED DESCRIPTION

The following describes embodiments of a chat system, a method of transmitting advertisements, and a recording medium according to the present disclosure with reference to the accompanying drawings. The embodiments are not intended to limit the scope of the present disclosure. Components of the embodiments described below include components that can be easily replaced by those skilled in the art, or components that are substantially the same.

### First Embodiment

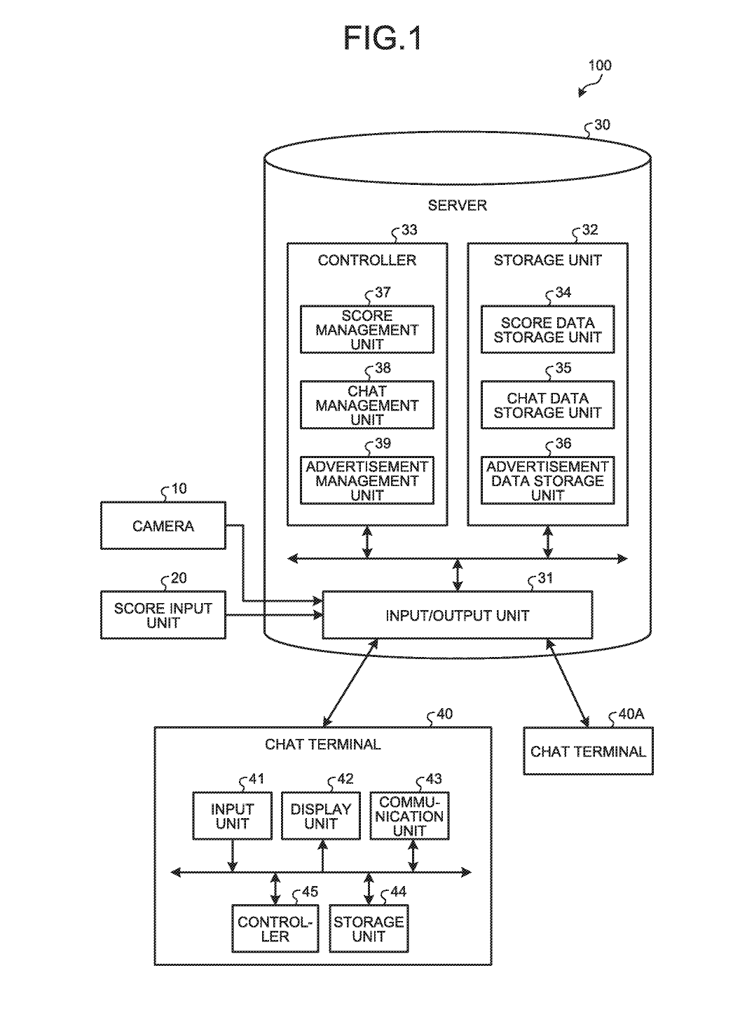

FIG. 1 is a block diagram illustrating an example of a chat system 100 according to a first embodiment of the present disclosure. The chat system 100 illustrated in FIG. 1 is used for, for example, sports matches such as baseball, in which the users chat about the match. Using the chat system 100 enables the users to let each other know the current situation of the match through chat, so that the users who are not able to join the match or directly watch the match can grasp the situation of the match, for example. The following describes the embodiments by using baseball as an example of a sports match, but the sports match is not limited thereto. The same applies to other sports matches such as soccer, volleyball, tennis, and badminton, for example. The chat system 100 can be used for other events such as dance competitions, piano competitions (music competitions), competitive Karuta championships (card games or table games tournaments), and karaoke competitions (singing competitions), in addition to sports matches.

As illustrated in FIG. 1, the chat system 100 includes a camera 10, a score input unit 20, a server 30, and a chat terminal 40. The camera 10 captures data of a match at, for example, a match venue. The data captured by the camera 10 is transmitted to, for example, the server 30, and is managed in the server 30. A single camera 10 or a plurality of cameras 10 may be used. The camera 10 is not necessarily included in the first embodiment.

The score input unit 20 inputs match situation data indicating a situation of the match to the server 30. In the first embodiment, for example, the match situation data indicating a situation of the baseball match is score data. The score data constitutes a score recorded in a baseball scorecard and each score data indicates an event constituting a series of events starting from a pitch of a pitcher. A score is an aggregation of score data. Every time the pitcher throws a ball, a plurality of pieces of score data are created, and a score is thus created. For example, suppose that there is a baserunner on the first base and the following batter flies out to the right fielder, and the baserunner on the first base is tagged out. In this case, score data indicating that the batter is put out, score data indicating a fly to the right field, and score data indicating the baserunner on the first base is put out are created, and these pieces of score data constitute a part of a score.

In addition to the examples of the score data described above, a score may include score data indicating actions of batters, actions of fielders, counts, advancing of baserunners, if any, and other actions of batters and fielders. Specifically, a score may include score data indicating a strike, a ball, a foul ball, a batting result, a batted ball, a fielder who fielded a batted ball, and an advancing result. The batting result indicates, for example, information such as an out, a single, a double, or a triple base hit, or a home run. The batted ball indicates information such as a grounder, a liner, a fly ball, or a bunt. The batted ball may be classified into more categories. The fielder who fielded a batted ball indicates information for specifying a fielder who fielded a batted ball or the position of the fielder. The advancing result indicates information about advancing of a baserunner, such as “first to second base”, and may additionally include actions of the batter and fielders.

The score input unit 20 is implemented by, for example, an application that inputs the aforementioned score data into the server 30 as electronic data. In this case, the score input unit 20 may be provided in a processing device such as a personal computer external to the server 30. Alternatively, the score input unit 20 may be provided in the server 30.

The server 30 centrally manages the chat system 100. For example, the server 30 receives score data input from the score input unit 20 and chat data indicating the content of chats corresponding to the match. The server 30 may receive captured data captured by the camera 10.

The server 30 manages various kinds of data including the data input as described above. Examples of the server 30 include, but are not limited to, a personal computer and a workstation.

The server 30 includes an input/output unit 31, a storage unit 32, and a controller 33. In the server 30, the input/output unit 31, the storage unit 32, and the controller 33 are connected through, for example, a bus line. The input/output unit 31 is connected to external devices such as the camera 10 and the score input unit 20, and receives data from the camera 10 and the score input unit 20. The input/output unit 31 is connected to a communication line, which is not illustrated. The input/output unit 31 receives data from external devices through the communication line. The input/output unit 31 outputs data to the external devices through the communication line.

The storage unit 32 is implemented by, for example, a volatile or nonvolatile memory such as a random access memory (RAM) or a read only memory (ROM), or a disc such as a magnetic disc. The storage unit 32 includes a score data storage unit 34, a chat data storage unit 35, and an advertisement data storage unit 36.

The score data storage unit 34 stores therein score data input to the server 30. The chat data storage unit 35 stores therein, for example, chat data indicating the content of chats corresponding to the match and applications, data, and computer programs for managing the chat system 100.

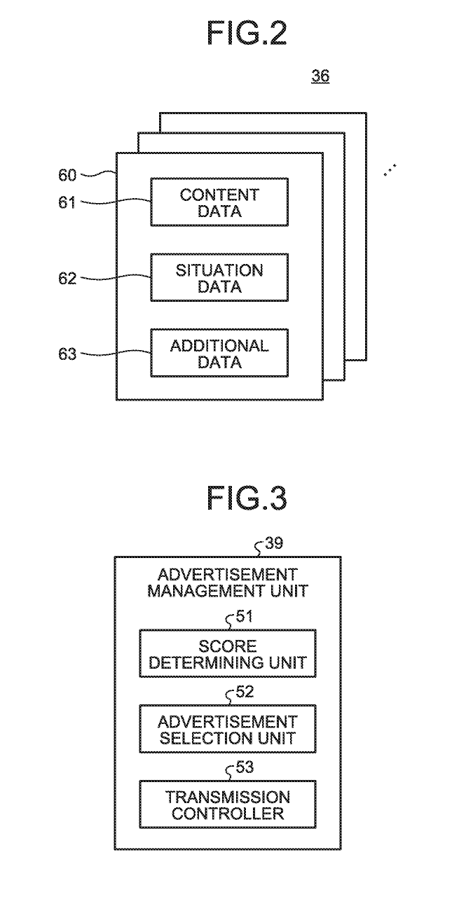

The advertisement data storage unit 36 stores therein advertisement data relating to advertisements. The advertisement data is data to be transmitted to, for example, the chat terminal 40. FIG. 2 is a diagram schematically illustrating an example of advertisement data 60 stored in the advertisement data storage unit 36. As illustrated in FIG. 2, the advertisement data 60 includes content data 61, situation data 62, and additional data 63. The advertisement data 60 may include transmission data that indicates transmission timing.

The content data 61 relates to the content of advertisements to be, for example, displayed on the chat terminal 40. The content data 61 includes, for example, image data such as a static image or a video, text data such as words or characters, and sound data. When, for example, the advertiser is a restaurant owner, the content data 61 includes text data such as “Would you like to come to our restaurant?” and image data such as pictures or illustrations of the restaurant and food, and such text data and image data are displayed on the chat terminal 40. When the advertiser is an application store that sells applications installable into the chat terminal 40, the content data 61 includes text data such as “Would you like to install an application having a function of XX?” and image data, and such text data and image data are displayed on the chat terminal 40. The type of business of the advertiser is not limited to the restaurant or application store described above, and may be other businesses such as a retailer that sells goods for use in the match.

The situation data 62 is data such as the score data indicating a situation relating to the match. For the situation data 62, for example, score data itself indicating a strike, a ball, a single base hit and the like may be set. The situation data 62 is not limited to the score data, and may be any data indicating a situation relating to the match. The situation data 62 may be data indicating a situation represented by a plurality of pieces of score data, such as “team has batted around”, “pitch count has reached a certain number”, “the number of stolen bases has reached a certain number”, or “match ends”.

For example, a situation “match ends” includes a plurality of possible results, such as the team won, the team lost, and a draw. In this regard, a combined situation including a situation and the match result may be set for the situation data 62, such as “match ended and team won” or “match ended and team lost”.

Advertisement data 60 corresponding to a result of the match can be generated by setting detailed content data 61 corresponding to each piece of situation data 62. Suppose that the advertiser is a restaurant owner. When the situation data 62 is set as “match ended and team won”, the content data 61 may include a mention of victory such as “Congratulations. Would you like to have a party for celebrating the victory?” When the situation data 62 is set as “match ended and team lost”, the content data 61 may include a mention of defeat such as “Sorry for the defeat. Would you like to have a review meeting?”

The additional data 63 indicates information different from the information relating to the match. The additional data 63 is set separately from the situation data 62. Examples of the additional data 63 include information about the location of the advertiser and information about the advertiser's room capacity. Such information can be pre-stored.

Suppose that the advertiser is a restaurant owner. When a situation “match ended” is set for the situation data 62 and information “location is near the match venue” is set for the additional data 63, the content data 61 may include a mention relating to both situation data 62 and additional data 63, such as “Have you enjoyed the match? Would you like to have a meal near the match venue?”

In addition, information that can be acquired through, for example, the communication line can be stored as the additional data 63. Examples of such information include traffic information around the match venue, weather information on the match day, and time information relating to time at which the match situation corresponds to the situation set for the situation data 62. Suppose that the advertiser is a restaurant owner. When a situation “match ended” is set for the situation data 62, and information “traffic congestion around the match venue” is set for the additional data 63, the content data 61 may be set as, for example, “Have you enjoyed the match? There is a traffic congestion around the match venue. Would you like to stop at our restaurant and have a meal?”, that is, the content data 61 may include a mention of anticipated conditions (traffic conditions, weather conditions) on the match day in addition to the content relating to the situation data 62, which indicates the situation of the match.

As described above, the advertisement data storage unit 36 stores therein a plurality of pieces of advertisement data 60 each including the content data 61, the situation data 62, and the additional data 63 that are individually set. The server 30 manages these pieces of advertisement data 60.

The storage unit 32 stores therein an advertisements transmission program that causes a computer to execute an acquisition process of acquiring match situation data indicating a situation of a match, the match situation data being input to a server that manages the match situation data, chat data indicating content of chats corresponding to the match, and advertisement data relating to advertisements, and a transmission process of transmitting the advertisement data, based on the acquired match situation data, from the server to a chat terminal that can receive the match situation data, the chat data, and the advertisement data and can generate chat data and transmit the generated chat data to the server.

The controller 33 includes a processor such as a central processing unit (CPU) and storage devices such as a RAM and a ROM.

The controller 33 includes a score management unit 37, a chat management unit 38, and an advertisement management unit 39. The score management unit 37 acquires score data received from the score input unit 20 and manages the score data. The score management unit 37 includes a management application for managing the score data. The score management unit 37 stores, for example, the score data input to the server 30 in the score data storage unit 34 in accordance with the processing of the management application. When the score data is stored in the score data storage unit 34, the score management unit 37 may add data indicating storage time to the score data.

The chat management unit 38 manages chat. The chat management unit 38 includes a management application for managing chat. The chat management unit 38 stores, for example, the chat data input to the server 30 in the chat data storage unit 35 in accordance with the processing of the management application. The chat management unit 38 manages chat for a plurality of chat groups. Each chat group is established based on, for example, a sport, a match, or a team. The chat management unit 38 performs various kinds of processing relating to chat for each chat group.

The chat management unit 38 includes a chat generating application that generates chat data in accordance with the input score data. The chat management unit 38 generates chat data in accordance with the input score data and stores the generated chat data in the chat data storage unit 35 in accordance with the processing of the chat generating application. For example, the chat management unit 38 can generate chat data indicating the content of score data in, for example, text form every time new score data is input. This configuration allows the users to check the updated score data as the information on chat upon every update of the score data. When the chat data is stored in the chat data storage unit 35, the chat management unit 38 may add data indicating the storage time to the chat data.

The advertisement management unit 39 manages, for example, advertisement data and transmission of the advertisement data. FIG. 3 is a block diagram illustrating an example of the advertisement management unit 39. As illustrated in FIG. 3, the advertisement management unit 39 includes a score determining unit 51, an advertisement selection unit 52, and a transmission controller 53.

The score determining unit 51 determines, based on the score data acquired by the score management unit 37, whether a situation has occurred that corresponds to, for example, score data, a match progress, or a match result that is set for the situation data 62 of the advertisement data 60. If the situation data 62 is certain score data, the score determining unit 51 determines whether the input score data corresponds to the certain score data set for the situation data 62. If it does, the score determining unit 51 determines that the situation set for the situation data 62 has occurred. If it does not, the score determining unit 51 determines that the situation set for the situation data 62 has not occurred.

When the situation data 62 is not simple score data but, for example, a combination of a match progress and a match result, the score determining unit 51 extracts the match progress and the match result based on the input score data and the score data stored in the score data storage unit 34, and determines whether the extraction result corresponds to the situation data 62. If it does, the score determining unit 51 determines that the situation set for the situation data 62 has occurred. If it does not, the score determining unit 51 determines that the situation set for the situation data 62 has not occurred.

The advertisement selection unit 52 selects a piece of advertisement data 60 that is based on the score data from a plurality of pieces of advertisement data 60 stored in the advertisement data storage unit 36. For example, when the score determining unit 51 determines that a situation set for the situation data 62 has occurred, the advertisement selection unit 52 selects advertisement data 60 including the situation data 62 upon such determination. If a plurality of pieces of advertisement data 60 meet the conditions of selection, the advertisement selection unit 52 may select all pieces of advertisement data 60 that meet the conditions, or may optionally select one or more pieces of advertisement data 60. Whether all pieces of advertisement data 60 that meet the conditions are selected or one or more pieces of advertisement data 60 are optionally selected may be preset and the setting can be later changed.

The transmission controller 53 performs a transmission process of transmitting the advertisement data 60. The transmission controller 53 transmits the advertisement data 60 selected by the advertisement selection unit 52 to the chat terminal 40. When the advertisement selection unit 52 selects a plurality of pieces of advertisement data 60, the transmission controller 53 transmits these pieces of advertisement data 60. When the advertisement selection unit 52 selects a single piece of advertisement data 60, the transmission controller 53 transmits the single piece of advertisement data 60.

The transmission controller 53 transmits the advertisement data 60 at timing based on the score data. For example, the transmission controller 53 can use selection of the advertisement data 60 by the advertisement selection unit 52 as a trigger to transmit the selected advertisement data 60. When the transmission timing of the advertisement data 60 is independently set, the transmission controller 53 transmits the advertisement data 60 at the set transmission timing.

The chat terminal 40 includes an input unit 41, a display unit 42, a communication unit 43, a storage unit 44, and a controller 45. The input unit 41, the display unit 42, the communication unit 43, the storage unit 44, and the controller 45 are connected through, for example, a bus line. Examples of the chat terminal 40 include a mobile phone, a smart phone, a tablet, a laptop computer and other mobile information terminals.

The input unit 41 can receive certain input operations for inputting information. The input unit 41 outputs indication signals to the controller 45 in response to the input operations. For the input unit 41, for example, an input device such as a touch panel is used. For the input unit 41, a button, a lever, a dial, a switch, or other input devices may be used in addition to or instead of the touch panel. The input unit 41 outputs an indication signal corresponding to a certain input operation. The display unit 42 displays various types of information including texts and images. The display unit 42 includes a display panel such as a liquid crystal panel. The display unit 42 can display information including a video.

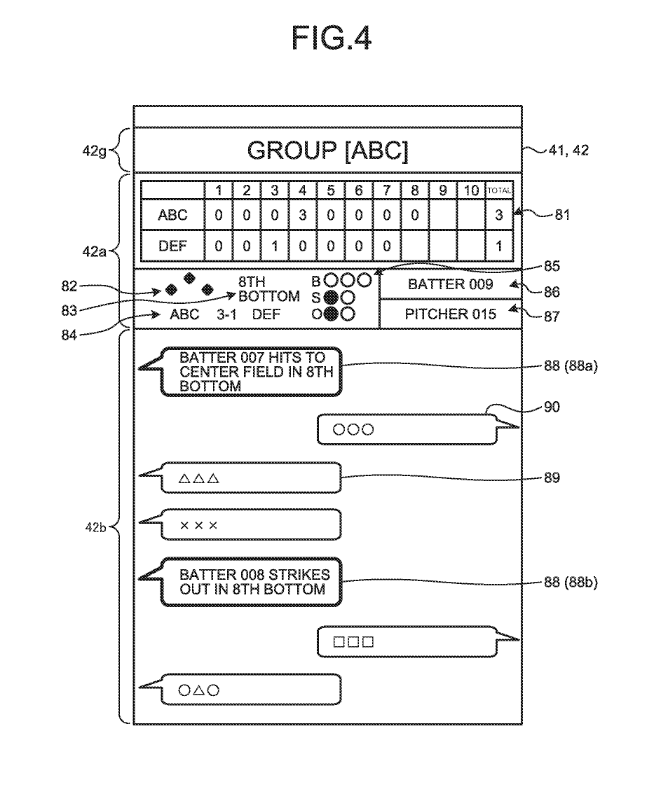

FIG. 4 is a diagram illustrating an example of the input unit 41 and the display unit 42 of the chat terminal 40 according to the first embodiment. As illustrated in FIG. 4, the chat terminal 40 includes, for example, the touch-panel input unit 41 and the display unit 42. In other words, a touch panel as the input unit 41 is overlaid on a display panel as the display unit 42.

The display unit 42 displays, for example, a score display area 42a, a chat display area 42b, and a group display area 42g. The score display area 42a displays score data. The score display area 42a displays, for example, a scoreboard 81 on which scores are displayed for each inning, an advancing display 82 on which the locations of the baserunners are displayed, an inning display 83 on which the current inning is displayed, a score display 84 on which the total score of each team is displayed, a count display 85 on which ball counts and out counts are displayed, a batter display 86 on which the current batter is displayed, and a pitcher display 87 on which the current pitcher is displayed. The displays included in the score display area 42a are not limited to those described above. Some of the displays above may be excluded, for example.

The chat display area 42b displays chat data. The chat display area 42b displays, for example, server messages 88 that are chat data generated by the server 30, other users' messages 89 that are chat data input from chat terminals 40A different from the chat terminal 40, and self-messages 90 that are chat data input from the chat terminal 40. The chat display area 42b may display the content data 61 of the advertisement data 60 transmitted from the server 30 as a message. For example, the server messages 88 represent, in text form, the content of score data input to the server 30. A server message 88a at an upper portion in FIG. 4 indicates that, for example, a batter 007 hit to the center field in the bottom of the eighth inning. A server message 88b at a lower portion in FIG. 4 indicates that a batter 008 struck out in the bottom of the eighth inning.

The server messages 88 and the other users' messages 89 are displayed on, for example, the left side of the chat display area 42b. The self-messages 90 are displayed on, for example, the right side of the chat display area 42b. The server messages 88 may be distinguished from the other users' messages 89 by, for example, being displayed in different frames. This configuration allows the users to distinguish the server messages 88 from the other users' messages 89. The group display area 42g displays information on a group to which the operator of the chat terminal 40 belongs.

When the operator performs an operation such as a touch operation or a scroll operation on a certain area on the surface of the touch panel, the input unit 41 outputs an indication signal including the position information of the area on which the operator performs the operation and the type of operation. The position information is set, for example, in accordance with the positions on the display unit 42. The configurations of the input unit 41 and the display unit 42 are not limited to those described above.

The communication unit 43 communicates information with external devices in a wired or wireless manner. The communication unit 43, for example, transmits and receives information such as chat data and score data to and from the external server 30.

The storage unit 44 includes a storage such as a hard disk drive or a solid-state drive. For the storage unit 44, an external storage medium such as a removal disk may be used. The storage unit 44 stores therein an operating system of the chat terminal 40, computer programs for controlling operations of the input unit 41, the display unit 42, and the communication unit 43, a chat application for chat, other computer programs, and data.

The controller 45 controls the input unit 41, the display unit 42, and the communication unit 43. The controller 45 performs, for example, calculations and processing in accordance with the indication signals from the input unit 41. The controller 45 includes a processor such as a CPU and storage devices such as a RAM and a ROM.

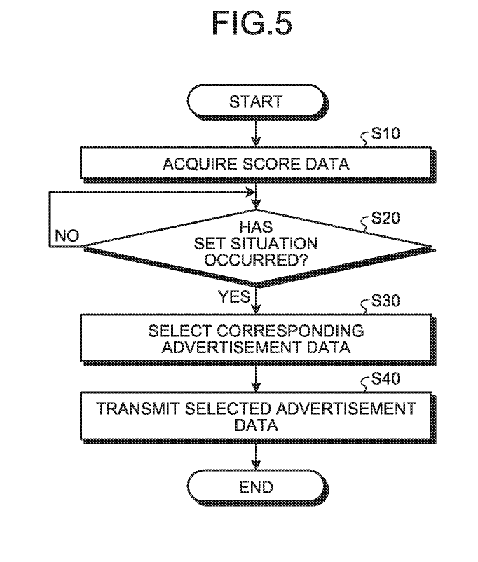

Described next is an operation of the chat system 100 having the configuration described above. FIG. 5 is a flowchart illustrating an example operation of the chat system 100 according to the first embodiment. FIG. 5 illustrates an example method of transmitting advertisements according to the first embodiment.

As the match proceeds, score data from the score input unit 20 is input to the input/output unit 31 of the server 30. In this case, the score management unit 37 acquires the score data and stores the score data in the score data storage unit 34 (Step S10). The chat management unit 38 generates chat data based on the input score data, and transmits the generated chat data to the chat terminal 40 and stores the generated chat data in the chat data storage unit 35. If chat data is transmitted to the server 30 from the chat terminal 40, the transmitted chat data is input to the input/output unit 31. In this case, the chat management unit 38 stores the transmitted chat data in the chat data storage unit 35.

The score determining unit 51 determines, based on the score data acquired by the score management unit 37, whether a situation has occurred that is set for the situation data 62 of the advertisement data 60 stored in the advertisement data storage unit 36 (Step S20). If the score determining unit 51 determines that the situation set for the situation data 62 has not occurred (No at Step S20), the process at Step S10 is repeated.

If the score determining unit 51 determines that the situation set for the situation data 62 has occurred (Yes at Step S20), the advertisement selection unit 52 selects, upon such determination, advertisement data 60 including the determined situation data 62 (Step S30). At Step S30, the advertisement selection unit 52 selects one or more pieces of advertisement data 60 in accordance with preset selection conditions.

For example, suppose that the following two types of advertisement data 60 are stored in the advertisement data storage unit 36, which are advertisement data 60 including situation data 62 set as “match ended and team won” and content data 61 set as “Congratulations. Would you like to have a party for celebrating the victory?”, and advertisement data 60 including situation data 62 set as “match ended and team lost”, and content data 61 set as “Sorry for the defeat. Would you like to have a review meeting?”

If, for example, the score determining unit 51 determines that a situation “match ended and team won” has occurred, the advertisement selection unit 52 selects the advertisement data 60 including the situation data 62 set as “match ended and team won”. The content data 61 included in this advertisement data 60 mentions the victory of the team and says “Congratulations. Would you like to have a party for celebrating the victory?” If, for example, the score determining unit 51 determines that a situation “match ended and team lost” has occurred, the advertisement selection unit 52 selects the advertisement data 60 including the situation data 62 set as “match ended and team lost”. The content data 61 included in this advertisement data 60 mentions the defeat of the team and says “Sorry for the defeat. Would you like to have a review meeting?” With this configuration, advertisement data 60 corresponding to the match result of the team is selected.

If the advertisement selection unit 52 selects advertisement data 60, the transmission controller 53 transmits the selected advertisement data 60 to the chat terminal 40 (Step S40). At Step S40, the transmission controller 53 uses selection of the advertisement data 60 by the advertisement selection unit 52 as a trigger to transmit the selected advertisement data 60.

As described above, the chat system 100 according to the first embodiment includes the server 30 that manages score data indicating a situation of a match, chat data indicating content of chats corresponding to the match, and advertisement data 60 relating to advertisements. The server 30 can transmit the score data, the chat data, and the advertisement data 60. The chat system 100 includes chat terminals 40 and 40A that can receive the score data, the chat data, and the advertisement data 60 transmitted from the server 30. The chat terminals 40 and 40A can generate the chat data and transmit the generated chat data to the server 30. The server 30 transmits the advertisement data 60 to the chat terminals 40 and 40A based on the score data.

The method of transmitting advertisements according to the first embodiment includes acquiring score data indicating a situation of a match, the score data being input to the server 30 that manages the score data, chat data indicating content of chats corresponding to the match, and advertisement data relating to advertisements, and transmitting, based on the acquired score data, the advertisement data 60 from the server 30 to the chat terminals 40 and 40A that can receive the score data, the chat data, and the advertisement data, and can generate the chat data and transmit the generated chat data to the server 30.

Transmitting the advertisement data 60 from the server 30 to the chat terminal 40 based on the score data can implement transmission of advertisement data 60 to the chat terminal 40 in accordance with the match situation.

In the chat system 100 according to the first embodiment, the server 30 manages a plurality of pieces of advertisement data 60, selects one or more pieces of advertisement data 60 from the pieces of advertisement data 60 based on the score data, and transmits the selected one or more pieces of advertisement data 60 to the chat terminal 40. With this configuration, advertisement data 60 suited to the match situation can be transmitted to the chat terminal 40.

In the chat system 100 according to the first embodiment, the server 30 transmits the advertisement data 60 to the chat terminal 40 at timing based on the score data. With this configuration, advertisement data 60 can be transmitted to the chat terminal 40 at timing suited to the match situation.

In the chat system 100 according to the first embodiment, the server 30 transmits the advertisement data 60 to the chat terminal 40 based on the score data and the additional data 63 indicating information different from match situations. With this configuration, advertisement data 60 suited to both match situation and other situations different from the match situation can be transmitted to the chat terminal 40.

### Second Embodiment

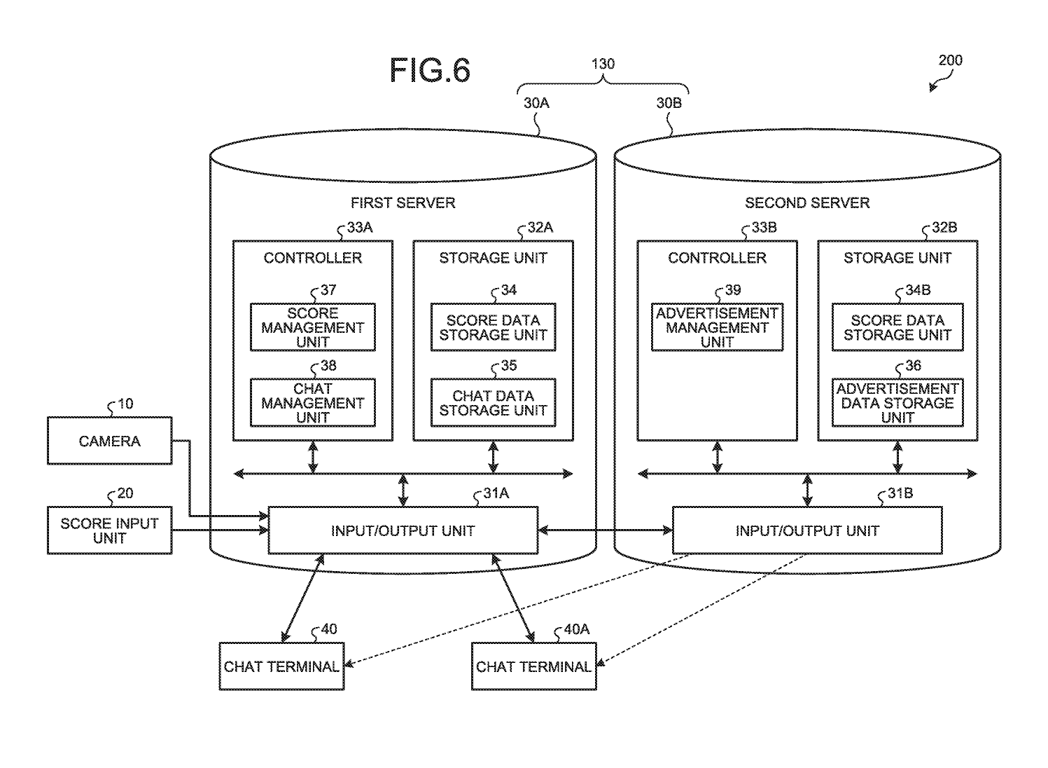

FIG. 6 is a block diagram illustrating an example of a chat system 200 according to a second embodiment of the present disclosure. The chat system 200 illustrated in FIG. 6 includes the camera 10, the score input unit 20, a server 130, and the chat terminal 40. The configurations of the camera 10, the score input unit 20, and the chat terminal 40 are the same as those in the first embodiment. The server 130 according to the second embodiment differs from the server 130 according to the first embodiment. The following mainly describes the differences between the first embodiment and the second embodiment.

The server 130 includes a first server 30A and a second server 30B. The first server 30A and the second server 30B are separate processing devices (e.g., personal computers or work stations). The server 130 according to the second embodiment is configured by a plurality of processing devices.

The first server 30A includes an input/output unit 31A, a storage unit 32A, and a controller 33A. The storage unit 32A includes the score data storage unit 34 and the chat data storage unit 35. The controller 33A includes the score management unit 37 and the chat management unit 38. The configurations of the score data storage unit 34, the chat data storage unit 35, the score management unit 37, and the chat management unit 38 can be the same as those in the first embodiment.

The second server 30B includes an input/output unit 31B, a storage unit 32B, and a controller 33B. The storage unit 32B includes a score data storage unit 34B and the advertisement data storage unit 36. The score data storage unit 34B stores therein the same kinds of information as those stored in the score data storage unit 34. The controller 33B includes the advertisement management unit 39. The configurations of the advertisement data storage unit 36 and the advertisement management unit 39 can be the same as those in the first embodiment. In other words, the advertisement management unit 39 includes, as in the first embodiment, the score determining unit 51, the advertisement selection unit 52, and the transmission controller 53.

In the server 130 according to the second embodiment, the score management unit 37 and the chat management unit 38 are provided separately from the advertisement management unit 39 in different processing devices. In the server 130 according to the second embodiment, the chat data storage unit 35 is provided separately from the advertisement data storage unit 36 in different processing devices.

In this configuration, upon reception of score data from the score input unit 20, the first server 30A transmits the score data from the input/output unit 31A to the second server 30B. Upon transmission of the score data from the first server 30A, the score data is input to the input/output unit 31B in the second server 30B. The controller 33B acquires the score data input to the input/output unit 31B and stores the acquired score data in the score data storage unit 34B in the storage unit 32B.

The score determining unit 51 in the advertisement management unit 39 determines, based on the acquired score data, whether a situation has occurred that is set for the situation data 62 of the advertisement data 60 stored in the advertisement data storage unit 36. If the score determining unit 51 determines that a situation set for the situation data 62 has occurred, the advertisement selection unit 52 selects, upon such determination, advertisement data 60 including the determined situation data 62. Upon selection of the advertisement data 60 by the advertisement selection unit 52, the transmission controller 53 transmits the selected advertisement data 60 to the first server 30A. The first server 30A then transmits the received advertisement data 60 to the chat terminal 40. The second server 30B may be configured to directly transmit the advertisement data 60 to the chat terminal 40.

In the chat system 200 according to the second embodiment, the server 130 includes the first server 30A that manages score data and chat data, and the second server 30B that manages advertisement data 60. The first server 30A transmits input score data to the second server 30B, and the second server 30B transmits, based on the score data transmitted from the first server 30A, the advertisement data 60 to the first server 30A or to the chat terminal 40. The first server 30A transmits the advertisement data 60 transmitted from the second server 30B to the chat terminal 40. This configuration allows an administrator of the chat system to manage the second server 30B independently without stopping the processing of the score management unit 37 and the chat management unit 38. Thus, the administrator can readily set the advertisement data 60 or change the setting thereof.

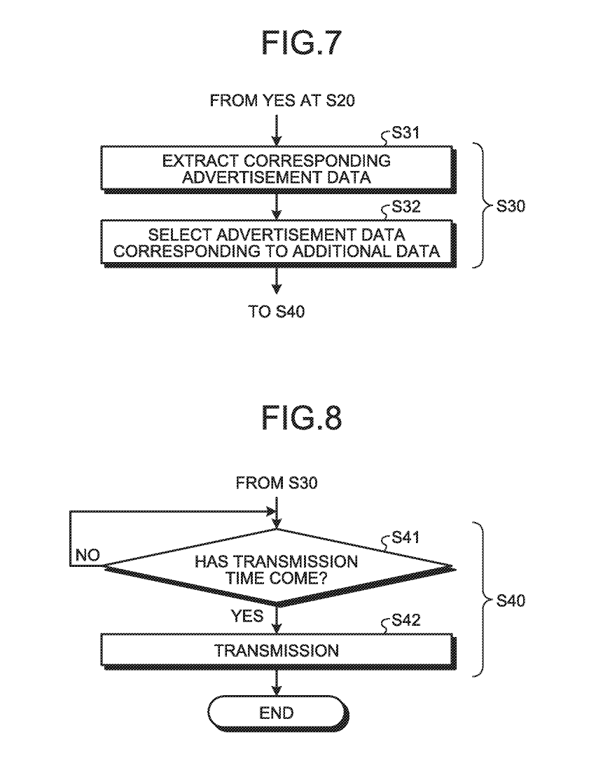

The technical scope of the present disclosure is not limited to the embodiments above, and can be modified as appropriate without departing from the spirit of the present disclosure. FIG. 7 is a flowchart illustrating an example operation of the chat system according to a modification. FIG. 7 illustrates some processes of the method of transmitting advertisements.

Although, in the embodiments above, the advertisement data 60 is selected based on the score data, the advertisement data 60 can be selected based on the score data and the additional data 63. As illustrated in FIG. 7, after the positive determination as YES at Step S20 in the flowchart in FIG. 5, the advertisement selection unit 52 extracts, from a plurality of pieces of advertisement data 60, advertisement data 60 including the situation data 62 corresponding to the positive determination as YES at Step S20 (Step S31). In this case, the advertisement selection unit 52 can extract one or more pieces of advertisement data 60 in the same manner as in the embodiments above. The advertisement selection unit 52 selects, from the extracted advertisement data 60, an advertisement in accordance with the additional data 63 (Step S32).

At Step S32, the advertisement selection unit 52 acquires data such as location data of the match venue, traffic situation data around the match venue, number data indicating the number of participants including players and supporters, weather data on the match day, and time data at which a situation set for the situation data 62 has occurred, through, for example, the communication line. The advertisement selection unit 52 then determines whether the acquired data corresponds to the data set for the additional data 63.

For example, if data about the location of the advertiser's restaurant is set for the additional data 63, the advertisement selection unit 52 determines whether the match venue is close to the location of the restaurant. For example, a threshold (e.g., distance) is preset and if the distance between the match venue and the restaurant is shorter than, or equal to, the threshold, the advertisement selection unit 52 can determine that the additional data 63 corresponds to the acquired data. In this case, the content data 61 may include content relating to the content of the additional data 63, such as “Have you enjoyed the match? Would you like to have a meal near the match venue?”, or “Have you enjoyed the match? There is a traffic jam around the match venue. Would you like to stop at our restaurant and have a meal?” With this configuration, the advertisement selection unit 52 can select the advertisement data 60 having the content that corresponds to the content of the additional data 63.

If the room capacity of the advertiser's restaurant is set for the additional data 63, the advertisement selection unit 52 determines whether the room capacity is greater than or equal to the number of participants including players and supporters. In this case, if the room capacity is greater than or equal to the participants including players and supporters, the advertisement selection unit 52 can determine that the additional data 63 corresponds to the acquired data.

If data about the weather and time is set for the additional data 63, the advertisement selection unit 52 determines whether the set weather and time correspond to the actual weather and time. If the set weather and time correspond to the actual weather and time, the advertisement selection unit 52 can determine that the additional data 63 corresponds to the acquired data.

The controller 33 may extract a restaurant or a store of an advertiser available to the players and the supporters based on information such as the match situation, the location of match venue, traffic information, the number of participants, weather, and time. For example, the chat system may be configured to allow the players and supporters to transmit information such as the current location and the number of participants from their chat terminals 40 to the server 30. In this case, the controller 33 of the server 30 acquires the transmitted information such as the current location and the number of participants. The controller 33 then extracts, from the advertisement data 60 stored in the advertisement data storage unit 36, advertisement data 60 that includes additional data 63 having information of a nearby place of the current location and additional data 63 having information of room capacity that is greater than or equal to the number of participants. Subsequently, the controller 33 may transmit information about the current location of the players and supporters and the number of participants to the advertiser of the extracted advertisement data 60. In this case, the chat system may be configured to allow an exchange of information between the participants including players and supporters and the advertiser via the server 30, and allow the participants to make a reservation.

FIG. 8 is a flowchart illustrating an example operation of the chat system according to another modification. FIG. 8 illustrates some processes of the method of transmitting advertisements. The process at Step S40 in FIG. 8 differs from the process at Step S40 in the flowchart in FIG. 5 according to the embodiments above. FIG. 8 illustrates processes after the process at Step S30 in the flowchart in FIG. 5. At the process (Step S40) of transmitting the advertisement data 60 selected by the advertisement selection unit 52, if the advertisement data 60 includes information on transmission time, the transmission controller 53 determines whether the transmission time has come (Step S41). If the transmission controller 53 determines that the transmission time has come (Yes at Step S41), the transmission controller 53 may transmit the advertisement data 60 (Step S42).

In the embodiments above, the display unit 42 of the chat terminal 40 displays both score display area 42a and chat display area 42b that are arranged adjacent to each other, but the configuration of the display unit 42 is not limited to this. For example, the display unit 42 does not necessarily display the score display area 42a.

In the embodiments above, the transmission controller 53 controls the process of transmitting the advertisement data 60, but the configuration of the transmission controller 53 is not limited to this. The transmission controller 53 may be configured to transmit only part of the advertisement data 60. For example, the transmission controller 53 may be configured to transmit only the content data 61.

According to the present disclosure, advertisements can be transmitted in accordance with match situations.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A chat system comprising:
a server configured to manage match situation data indicating a situation of a match, chat data indicating content of chats corresponding to the match, and advertisement data relating to advertisements, and transmit the match situation data, the chat data, and the advertisement data; and
a chat terminal configured to receive the match situation data, the chat data, and the advertisement data transmitted from the server, generate the chat data, and transmit the generated chat data to the server, wherein
the server transmits the advertisement data to the chat terminal based on the match situation data.

2. The chat system according to claim 1, wherein the server manages a plurality of pieces of advertisement data, selects one or more pieces of advertisement data from the pieces of advertisement data based on the match situation data, and transmits the selected one or more pieces of advertisement data to the chat terminal.

3. The chat system according to claim 1, wherein the server transmits the advertisement data to the chat terminal at timing based on the match situation data.

4. The chat system according to claim 1, wherein the server transmits the advertisement data to the chat terminal based on the match situation data and additional data indicating information different from the situation of the match.

5. A method of transmitting advertisements, the method comprising:
acquiring match situation data indicating a situation of a match, the match situation data being input to a server that manages the match situation data, chat data indicating content of chats corresponding to the match, and advertisement data relating to advertisements; and
transmitting the advertisement data, based on the acquired match situation data, from the server to a chat terminal configured to receive the match situation data, the chat data, and the advertisement data, generate the chat data, and transmit the generated chat data to the server.

6. A non-transitory computer readable recording medium recording therein an advertisements transmission program for causing a computer to execute:
an acquisition process of acquiring match situation data indicating a situation of a match, the match situation data being input to a server that manages the match situation data, chat data indicating content of chats corresponding to the match, and advertisement data relating to advertisements; and
a transmission process of transmitting the advertisement data, based on the acquired match situation data, from the server to a chat terminal configured to receive the match situation data, the chat data, and the advertisement data, generate the chat data, and transmit the generated chat data to the server.
